(19) United States
(12) Patent Application Publication
(10) Pub. No.: US 2015/0123310 A1
(43) Pub. Date: May 7, 2015

(54) METHOD FOR INJECTION MOLDING END MUCKETS TO A PREVIOUSLY MOLDED VEHICLE PANEL AND PRIOR TO INSTALLATION OF A SEPARATELY EXTRUDED AND ELONGATED COMPRESSION SEAL

(71) Applicant: U.S. Farathane Corporation, Auburn Hills, MI (US)

(72) Inventor: STEPHEN G. LEONARD, Waterford, MI (US)

(21) Appl. No.: 14/596,931

(22) Filed: Jan. 14, 2015

Related U.S. Application Data
(63) Continuation-in-part of application No. 14/244,842, filed on Apr. 3, 2014.
(60) Provisional application No. 61/874,556, filed on Sep. 6, 2013.

(51) Int. Cl. B29C 45/16

(52) U.S. Cl. CPC B29C 45/1671; B29C 2045/1673; B29L 2009/00
USPC 264/250

(57) ABSTRACT

A method for injection molding a pair of end muckets to a previously injection molded panel and prior to attaching a separately formed seal. The method includes the step of initially forming a vehicle panel from a first material in a closed cavity, following which a second stage injection molding process forms a pair of end muckets onto the panel. The separately formed seal exhibits an elongated profile and is inter-fitted between the end muckets, concurrent with being affixed to an extending surface of the panel, and to provide interface support between the seating ends of the seal and the adjoining vehicle fenders. Additional steps include injection molding a first plasticized materials into a closed cavity configuration established between assembled mold halves in order to initially mold the panel, following which a second plasticized material molds the end muckets along with additional wiper and windshield seals.

### CROSS-REFERENCE TO RELATED APPLICATIONS

This application is a Continuation-in-part of application Ser. No. 14/244,842 filed on Apr. 3, 2014. Application Ser. No. 14/244,842 claims the benefit of U.S. Provisional Application 61/874,556 filed on Sep. 6, 2013, the contents of which are incorporated herein in their entirety.

This application claims the benefit of U.S. Ser. No. 14/244,842, filed Apr. 3, 2014, which in turn claims the priority of U.S. Provisional Application 61/874,556 filed on Sep. 6, 2013, the contents of which are incorporated herein in its entirety.

### FIELD OF THE INVENTION

The present invention teaches a method for injection molding a pair of seal end supporting end muckets to a previously molded vehicle panel (e.g. cowl). The panel is typically produced during an initial injection molding operation and can be constructed of a polypropylene (PP), thermoplastic olefin (TPO) or like material.

The end muckets are formed during the subsequent (or second stage) injection molding operation, such including a second shot thermoplastic elastomer (TPE) or thermoplastic vulcanizate (TPV), and occurring concurrent with the injection molding of additional features associated with the panel/cowl construction and including any of circular wiper seal portions (these arranged within aperture locations of the cowl associated with wiper blade support shafts), as well as cowl edge to windshield extending seals.

The present method contemplates the installation of a separately configured elongated seal (such as in one non-limiting application including an extruded compression seal), and such as which can be formed at any point prior to, concurrent with or subsequent to the two stage injection molding process. The seal can be manipulated and installed in extending fashion along the panel/cowl in a fashion such that its elongated ends are inter-fitted between the opposing and inwardly facing receiving locations of the panel molded end muckets. The elongated seal can include anchor portions for securing through apertures formed along the panel. Alternately, the seal can be chemically or mechanically bonded to the panel, either prior to or following the injection molding formation of the panel.

### BACKGROUND OF THE INVENTION

The prior art discloses a multi-stage process for injection molding a vehicle panel (such as a cowl) from a first material (e.g. polypropylene or thermoplastic olefin), and during a first stage molding operation. Subsequent to the first molding operation, additional features including windshield seals and wiper pivot seals are formed with the panel during a second stage injection molding operation, these drawn from a second material (e.g. thermoplastic elastomer or thermoplastic vulcanizate).

End muckets or mucket seals are also defined in the relevant automotive art to reference any attaching or sealing portion secured or configured with a body panel, door or the like, not limited to a vehicle cowl. In the prior art, such mucket seals are molded in a separate operation (apart from the dual stage injection molding of the cowl/panel and second stage seals), the mucket seals subsequently being secured to extending ends of the separately formed (e.g., extruded) seal. At this point, the elongated seal with pre-attached end muckets are affixed to the extending surface of the molded panel.

As such, the muckets are provided as separate and previously formed components, requiring that they be pre-placed in correct aligning fashion along with the previously created and applied extruded seal secured to the body panel/cowl, and prior to the end muckets being mechanically or adhesively secured such as to the ends of the extruded or otherwise formed seal component. Disadvantages associated with the prior art fabrication and attachment of the end muckets include necessitating bulk transport and storage requirements of the muckets, and further requiring that they be successively pre-placed in correct aligning fashion, along with the previously created and applied extruded seal secured to the body panel/cowl, and prior to the end muckets being mechanically or adhesively secured such as to the ends of the extruded seal component.

### SUMMARY OF THE INVENTION

The present invention discloses a method for injection molding a pair of end muckets as part of a second stage injection molding operation, such as also including the concurrent formation of wiper pivot seals and windshield seals, onto a previously (first stage) injection molded vehicle panel (e.g. cowl). The present invention improves upon the inefficiencies associated with the prior art, and by avoiding the requirement of having to separately mold the end muckets, transport the same for subsequent attachment to the separately extruded seal, and prior to attaching to the molded panel/cowl.

The vehicle panel further includes the cowl panel being configured with an exposed and width extending channel which is adapted for receiving the elongated seal in resistive engaging fashion. The advantage of molding the pair of end supporting muckets into the cowl panel provides both material shaping and fabricating savings, while establishing interface support between the seating ends of the seal and the adjoining vehicle fenders.

In application, the elongated seal is adapted to being incorporated into any of a hood to radiator, rocker, front grille, rear trunk, deck lid or lift gate application. As is also known, end muckets (also termed mucket seals) are defined in the relevant automotive art to reference any attaching or sealing portion secured or configured with a body panel, door or the like, not limited to a vehicle cowl, and which can also be provided in combination with the attachment of the previously formed extruded seal. End muckets as described in the present application are further understood to include any three dimensional boot or other multi-sided shaped article, such as which is formed of a TPE (thermoplastic elastomer) or thermoplastic vulcanizate injection molded material.

### BRIEF DESCRIPTION OF THE DRAWINGS

Reference will now be made to the attached drawings, when read in combination with the following detailed description, wherein like reference numerals refer to like parts throughout he several views, and in which:

FIG. 1 is an illustration of a tri-extruded elastomeric hood to cowl seal according to one non-limiting embodiment of the present invention;

FIG. 2 is an enlarged end perspective of the seal depicted in FIG. 1 and showing the closed polygonal shape exhibited by the TPV or other softer material, such as which can also exhibit a frictional coefficient reducing olefinic based slip coat applied there-over, and to which is additional coextruded a harder (filled or unfilled polypropylene) material component for resistively engaging within a channel defined in the vehicle cowl structure;

FIG. 3 is a further cutaway of the seal and which better depicts the cross sectional engagement profile of the more rigid engagement material;

FIG. 4 is an underside rotated perspective view of a cowl panel configured with an exposed and width extending channel adapted for receiving the seal of FIG. 1, a pair of end supporting muckets being integrated into the cowl panel for providing interface support between the seating ends of the seal and the adjoining vehicle fenders;

FIG. 5 is an enlarged partial end view illustration of a selected mucket engaged to the cowl panel;

FIG. 6 is an inverted view of the cowl panel and mucket depicted in FIG. 5;

FIG. 7 is a perspective view similar to that shown in FIG. 4 and which illustrates the seal of FIG. 1 in installed fashion;

FIG. 8 is an enlarged partial end view illustration of a selected mucket engaged to the cowl panel and in cooperation with the snap-engagement of the tri-extruded seal shown in substantial transparency;

FIG. 9 is an inverted view of the cowl panel and mucket depicted in FIG. 8 and illustrating the underside engagement of the resisting fitting and projecting portions integrated into the harder material into the track receiving features of the cowl panel;

FIG. 10 is an illustration similar to that depicted in FIG. 4 and illustrating an arrangement of injection molded end muckets formed into the cowl panel following attachment of the previously extruded seal, in combination with the concurrent formation of injection molded wiper seals within additional aperture locations of the cowl panel;

FIG. 11 is an enlarged partial end view illustration of a selected and TPE injection molded mucket, similar to as previously shown in FIG. 5, engaged to the cowl panel;

FIG. 12 is an inverted view of the cowl panel, again similar to FIG. 6, and depicting the injection molded mucket of FIG. 11;

FIGS. 13A and 13B are a pair of illustrations according to the Prior Art and which illustrate the separate formation of the end muckets pre-attached to the ends of the separately extruded (or otherwise formed) seal, along with the subsequent assembly of the seal and end muckets to the molded panel;

FIGS. 14A and 14B illustrate a pair of views including a second stage injection molding process for forming each of the end muckets, wiper pivot seals and windshield seal to the previously injection molded panel, as well as the subsequent attachment of the separately formed seal to panel in inter-fitting fashion between the second stage molded end muckets; and

FIG. 15 is an exploded view of a mold assembly for producing the cowl panel in a first injection molding step, with the various end muckets, wiper pivot seals and cowl edge extending windshield seal all being produced in a second injection stage.

### DETAILED DESCRIPTION OF THE PREFERRED EMBODIMENTS

As previously described, the present invention discloses a method for injection molding a pair of seal supporting end muckets to a previously molded vehicle panel. The seal, without limitation, can include any construction and, in particular, can be a coextruded or tri-extruded bulb seal which is constructed of at least one softer and one harder polymer material for various in-vehicle applications. Such seals can be integrated along extending edge interfaces associated with the cowl to hood, rocker seal, grill seal, rear trunk and deck lid seals, lift gate seal, etc. Among other advantages, the seal eliminates the need for a secondary molded attachment pin, as it is integrated into the part.

One non-limiting depicted variant of cowl to hood seal provides a tri-extruded article, including a base attaching material exhibiting a more rigid filled or unfilled polypropylene, a polygonal and interiorly hollowed softer thermoplastic olefin, thermal plastic vulcanite, ethylene propylene diene monomer or the like, and an olefinic based slip coat which is coated or otherwise post applied and cured about the part and which provides a lowered coefficient of friction, such as during installation of the anchoring base material into a slot or channel associated with the mounting location. One non-limiting application of the tri-extruded seal located between the cowl and glass also depicts the use of a snap-in assembly with overlap, this including integrated end muckets which conform to an edge profile of the vehicle fender.

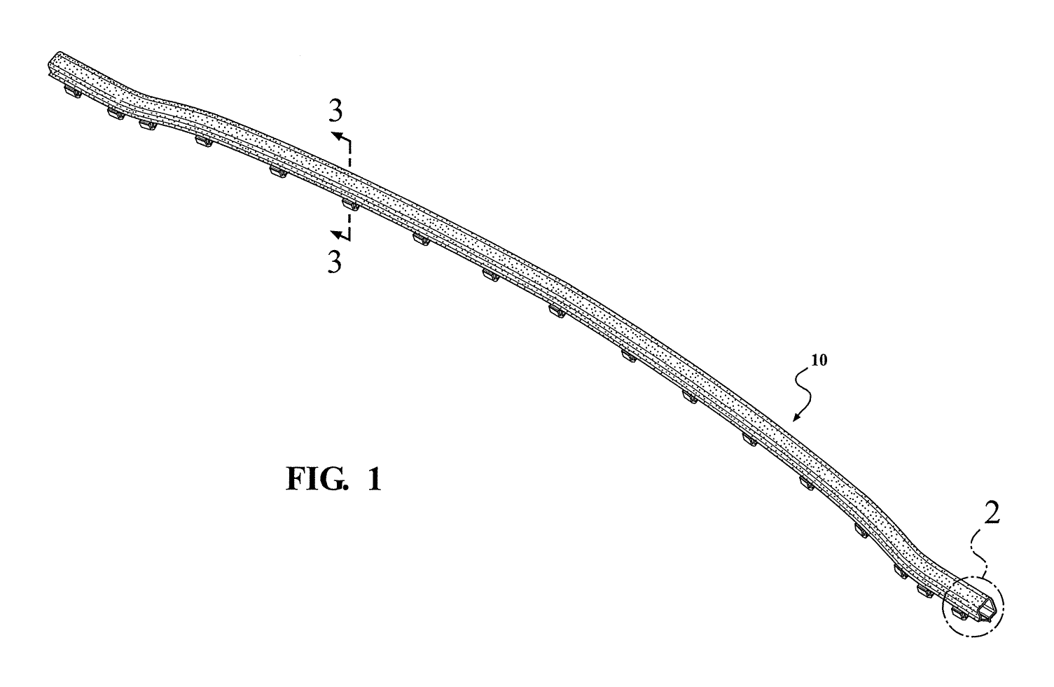

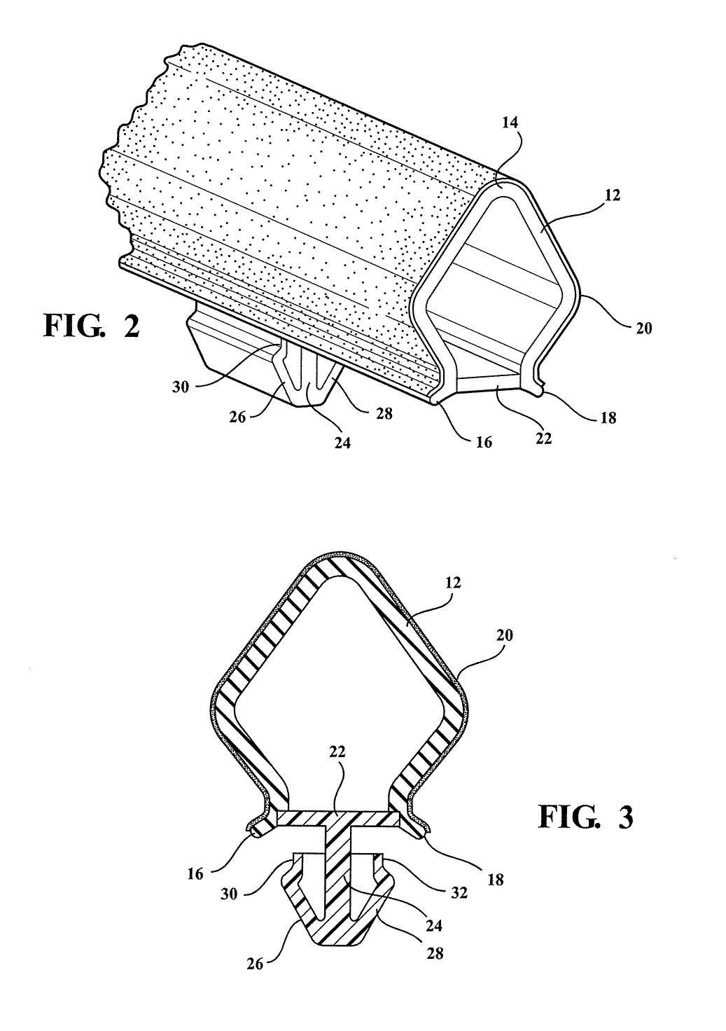

Referring now to the illustrations, FIG. 1 generally illustrates at 10 a tri-extruded elastomeric hood to cowl seal according to one non-limiting embodiment of the present invention. As further referenced in each of enlarged end perspective of FIG. 2 and further cutaway of FIG. 3, an upper bulbous shaped portion 12 is provided of a softer material and which can include any suitable elastomeric alloy such as a thermoplastic elastomer (TPE) or thermal plastic vulcanite (TPV), ethylene propylene diene rubber (EPDM) or other softer material.

The upper portion 12 as shown exhibits, according to one non-limiting example, a multi-sided (pseudo rectangular) profile in cross section with curved perimeter defining edges and which collectively defines a hollow interior, this in order to facilitate controlled and cushioning collapse of the upper portion 12 such as when compressed by an opposing inner rear surface of a vehicle hood or other moveable or stationary component associated with the vehicle (not shown). As further shown, the upper portion 12 exhibits a generally conical pointed upper end 14 and a pair of outwardly flared lower ends 16 and 18. A slipcoat 20 can be coated over the upper portion 12 and can include any type of plastic olefinic based grade or post applied and cured material, such as which reduces a coefficient of friction of the material in use among other advantages.

Co-extruded with the softer upper portion 12 is a harder/more rigid and elongated base material, this including an upper most planar mounting ledge 22 exhibiting a given width with opposite extending edges, along which the spaced lower ends 16 and 18 of the upper softer material 12 are engaged during the co-extrusion process (as best shown in the enlarged end view of FIG. 2). Referring again to FIGS. 2-3, the base material further includes a plurality of spaced apart and integrally projecting anchor portions which each include a central support 24, and with a pair 26 and 28 of reverse and angled beams extending from an extending end of the central support 24, the beams terminating in configured (uppermost and non-linear outer edge defining) profiles 30 and 32 which facilitate mounting of the anchor portions within associated seating structure of the cowl or other supporting location to which the base material is secured in a fashion which permits the softer upper material 12 to project upwardly in a manner to be engaged by the vehicle hood, trunk or the like.

The base material and associated anchor portion can further be constructed of a filled or unfilled polypropylene (PP), a thermoplastic olefin (TPO), a more dense EPDM material or the like. As with the upper portion 12, the base material and anchor portion can further exhibit an overlay application of the slip coat 20 or other suitable material in order to enhance its operating properties.

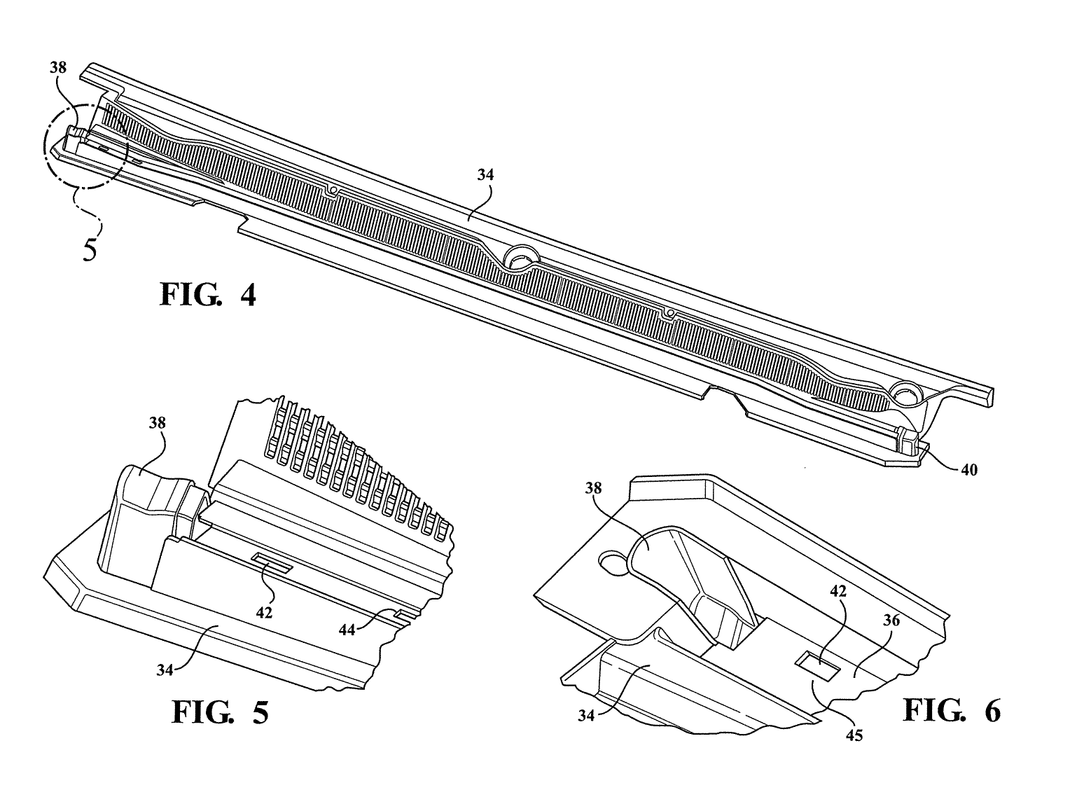

FIG. 4 is an underside rotated perspective view of a cowl panel 34 configured with an exposed and width extending channel, see recessed surface 36, and which is adapted for receiving the seal 10 of FIG. 1. A pair of end supporting muckets (see at 38 and 40 in FIG. 4 with selected mucket 38 further depicted in enlarged fashion in FIGS. 5-6), are provided and are integrated into the cowl panel 34 for providing interface support between the seating ends of the seal 10 and the adjoining vehicle fenders (not shown).

Further best shown in FIGS. 5 and 6 are a series of spaced apart and rectangular shaped apertures, referenced by inner perimeter surfaces 42 and 44 defined in a planar base surface 45 of the cowl panel 34, these being dimensioned to resistively seat and restrain each of the plurality of spaced apart anchor portions (see as further best shown in the underside inverted view of FIG. 9) in the manner shown. The seal 10 is then installed within the track profile of the cowl panel 34 (or other suitably configured vehicle panel), this as further depicted in FIG. 9 and without the requirement of secondary molded attachment pins or other fasteners.

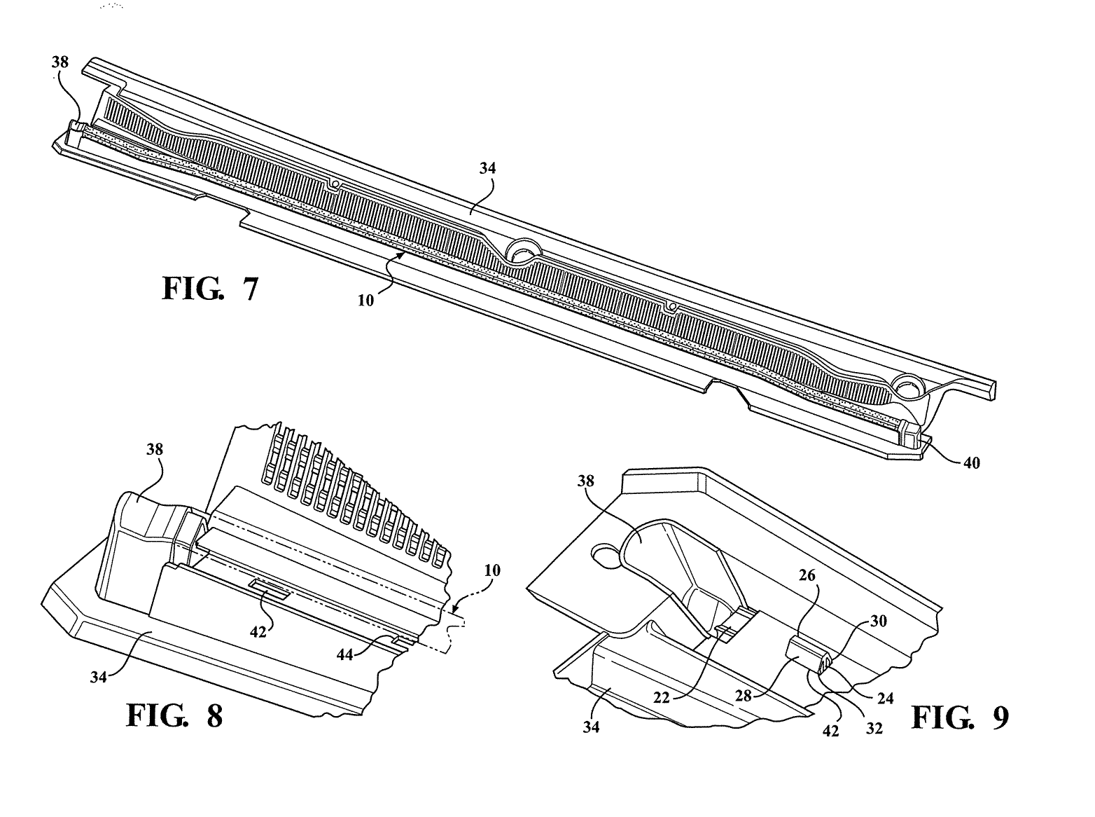

The succeeding environmental perspective of FIG. 7 depicts the elongated seal 10 installed within the cowl structure and so that the upper softer portion 12 projects in a fashion so that it can be contacted by the inner edge proximate surface of the vehicle hood. FIG. 8 and inverted FIG. 9 are enlarged partial end view illustrations of selected mucket 38 engaged to the cowl panel 34 and in cooperation with the snap-engagement of the tri-extruded seal 10, which in this illustration is shown in substantial transparency.

Referring now to FIG. 10, an illustration similar to that depicted in FIG. 4 is shown of a further variant illustrating an arrangement of injection molded end muckets, see at 38′ and 40′, and which are injection molded into the cowl panel 34 during a second stage injection molding process this in combination with the concurrent formation of injection molded wiper pivot seals 46 and 48 within additional aperture locations (see inner perimeter walls 50 and 52) of the cowl panel, and along with an edge extending windshield seal 53

As previously described, the corresponding method of the present invention contemplates an initial injection molding operation which forms the cowl 34 (or other vehicle panel), such as which can be constructed of a polypropylene (PP), thermoplastic olefin (TPO) or like material. A subsequent injection molding operation forms the pair of opposite end located mucket seals 38′ and 40′, such including a second shot thermoplastic elastomer (TPE) or thermoplastic vulcanizate (TPV) and occurring concurrent with the injection molding of additional features associated with the cowl construction, again including circular wiper pivot seals 46 and 48 (these again arranged within aperture locations of the cowl associated with wiper blade support shafts), as well as cowl edge extending windshield seals 53 (again FIG. 10).

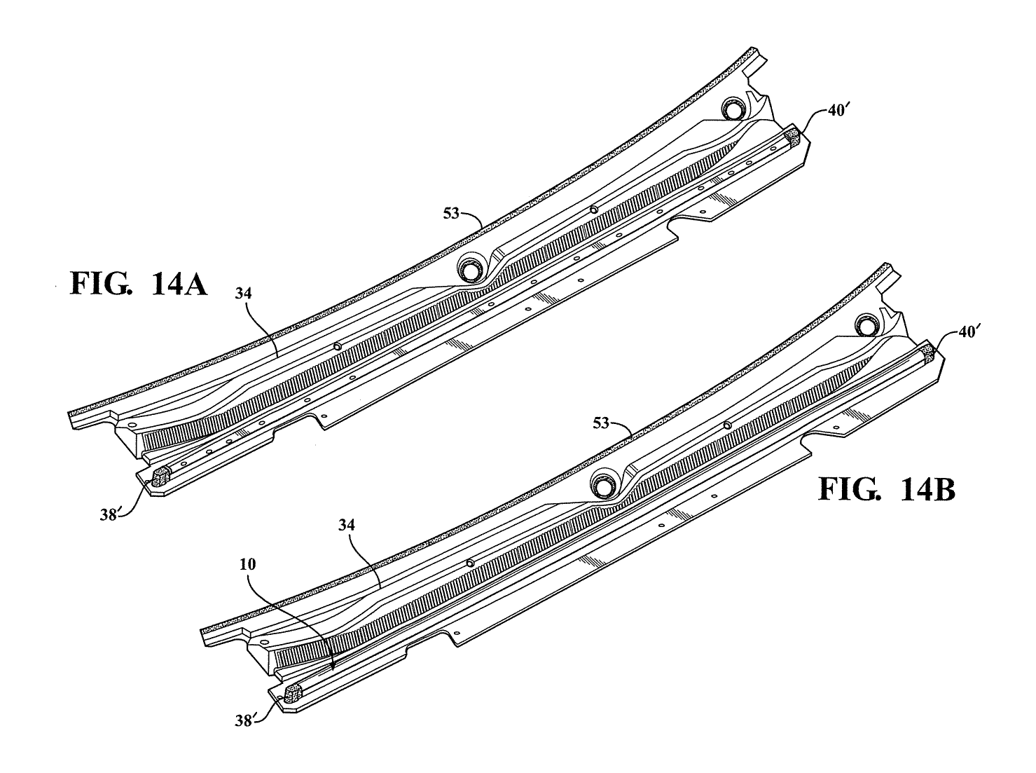

As further assisted by reference to the illustrations of FIGS. 14A-14B, the present method contemplates the initial formation of the cowl 34 or other suitable vehicle body panel during a first stage injection molding operation utilizing a standard mold construction. Following formation and sufficient curing of the cowl 34, a second injection molding operation (such as which can occur in the same mold) is employed for injection molding the end muckets 38′ and 40′, along with the wiper pivot seals 46 and 48 and the windshield edge seal 53.

The compression seal 10 (or other suitable elongated seal) is then engaged in extending fashion along the panel, such as by engaging its clip or anchor portions (see as again best shown in FIG. 9) to the mounting apertures formed in the cowl panel 34. During installation of the seal 10, its opposite ends seat in proximity to the inwardly open receiving ends of the muckets (see again example of mucket 38′ in FIG. 12). Upon installation of the cowl 34, the widthwise secured seal is engaged by a further vehicle component, such as an inner edge of a hood.

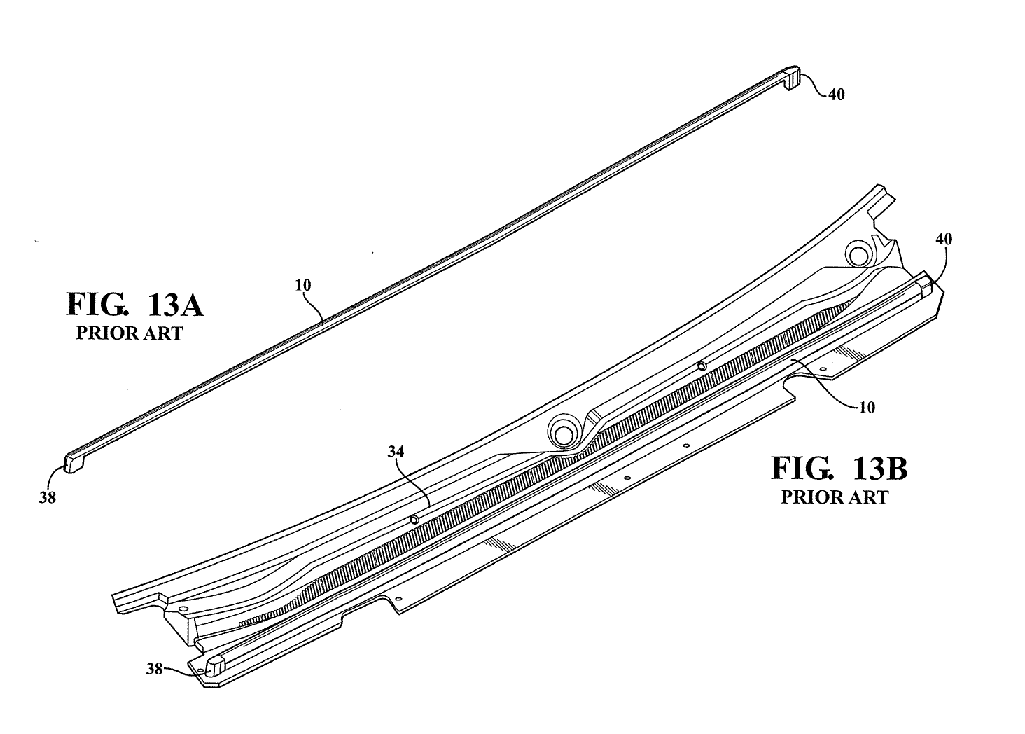

In contrast, and as depicted in FIGS. 13A-13B, the Prior Art method for installing the muckets 38 and 40 requires that they be pre-produced in bulk and transported to the final molding operation. In particular, the end muckets 38/40 are attached (including molding or otherwise fabricating) to the ends of the pre-extruded seal 10 (FIG. 13A), following which the seal (also termed a hood seal) is secured to the surface of the cowl in the manner depicted in FIG. 13B.

Previously, such end muckets were provided as separate and previously formed components, requiring that they be pre-placed in correct aligning fashion along with the previously created and applied extruded seal secured to the body panel/cowl, and prior to the end muckets being mechanically or adhesively secured such as to the ends of the extruded seal component.

As also discussed, previous versions of end muckets were provided as separate and preformed components, this necessitating bulk transport and storage requirements and further requiring that the muckets be successively pre-placed in correct aligning fashion, along with the previously created and applied extruded seal secured to the body panel/cowl, and prior to the end muckets being mechanically or adhesively secured such as to the ends of the extruded seal component.

The present method improves over the prior art method of pre-producing the muckets in bulk, following which they are attached to the ends of the elongated seal prior to the seal being assembled to the cowl panel. Without limitation, the present invention contemplates installation of the pre-extruded compression seal 10 at any of an initial pre-placement step (prior to the initial stage injection molding formation of the cowl panel), or an intermediate step following the injection molding of the cowl, as well as alternately following completion of the two stage injection molding protocol for subsequently forming the end muckets, circular inner wiper pivot seal portions and linear edge extending windshield seal. In the middle or latter instances, the compression seal can be manipulated and installed in extending fashion along the cowl (as well as inter-fitting between the pre-formed end muckets) this including resistively engaging the underside anchor portions of the elongated extruded seal into the apertures defined in linearly spaced fashion along the cowl interior.

As is also known, end muckets or mucket seals are defined in the relevant automotive art to reference any attaching or sealing portion secured or configured with a body panel, door or the like, not limited to a vehicle cowl, and which can also be provided in combination with the attachment of the previously formed extruded seal. The end muckets as described in the present application are further understood to include any three dimensional boot or other multi-sided shaped-article.

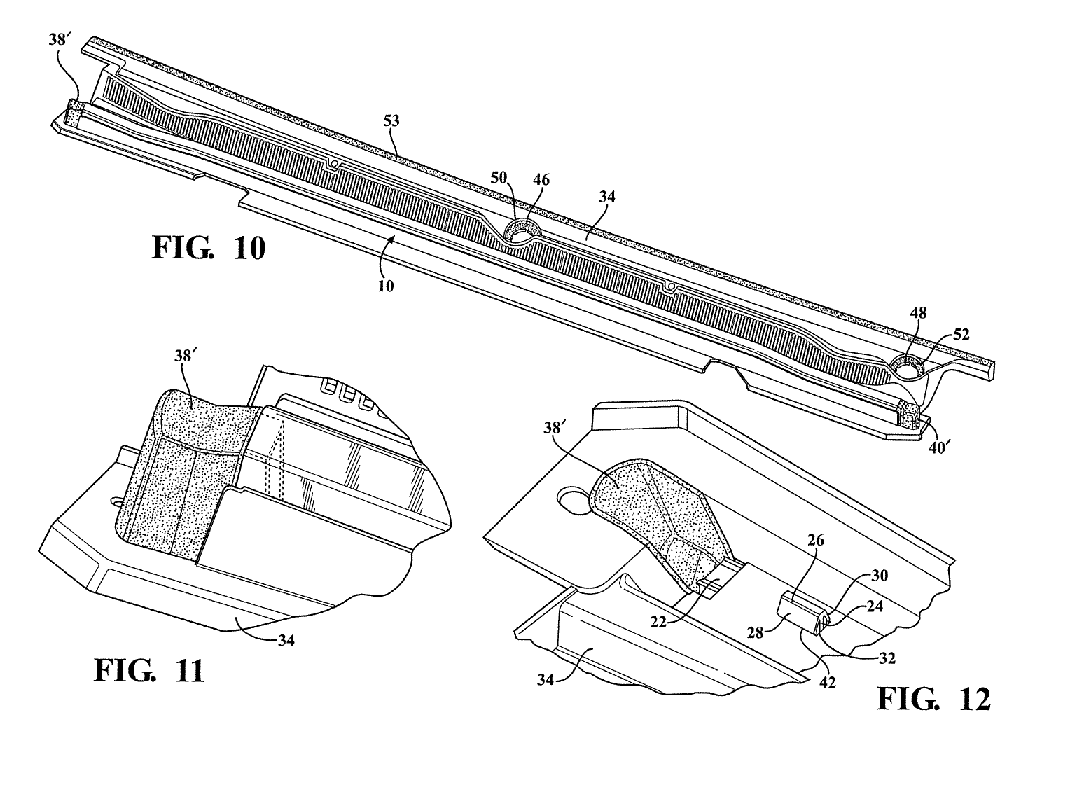

FIG. 11 is an enlarged partial end view illustration of a selected and TPE injection molded mucket, similar to as previously shown in FIG. 5, engaged to the cowl panel. FIG. 12 is an inverted view of the cowl panel, again similar to FIG. 6, and depicting the injection molded mucket of FIG. 11. The construction of the cowl panel 34 and compression seal 10 is further understood to be repeated from the description of FIGS. 1-9, it again being understood that the method for injection molding the end mucket feature can be also integrated into other combination panel and elongated seal designs, not limited to those described herein. It is also understood that the configuration of the mucket seals 38′ and 40′ can be otherwise identical to those shown at 38 and 40 in FIGS. 1-9, it further being understood that the second shot injection molding process enables the creation of any alternatively configured end mucket profile, as well as providing ease of modification to the injection molded shaping of the wiper seals 46/48 and the like.

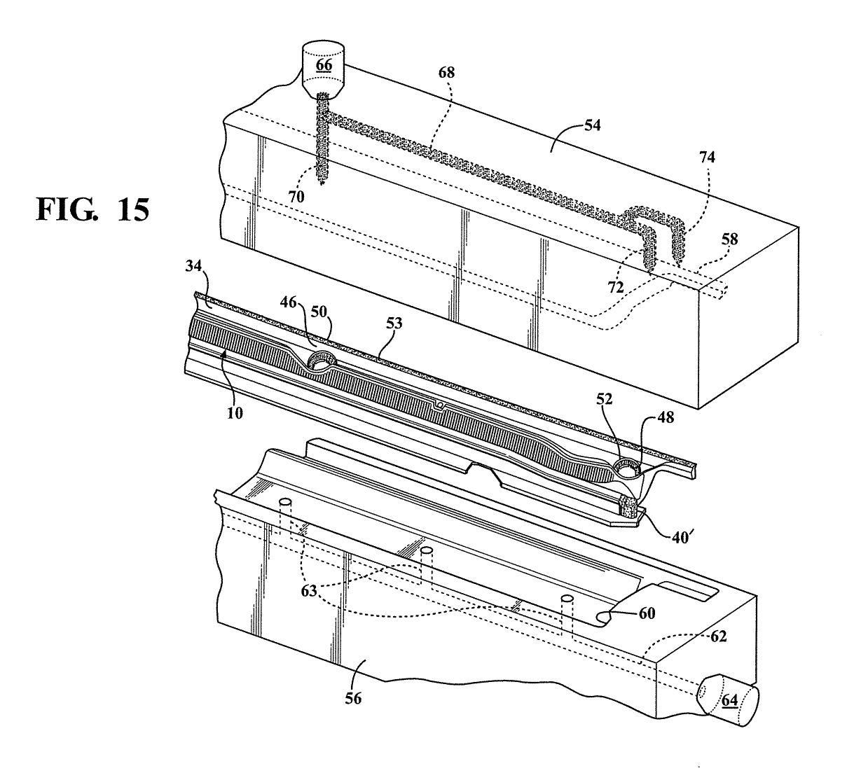

Proceeding finally to FIG. 15, an exploded view of a mold assembly is shown for producing the cowl panel 34 in a first injection molding step, with the various end muckets 38′/40′, wiper seals 46 and 48, and cowl edge extending windshield seal 53 produced in a second injection stage. As is further understood from the previous description, the previously extruded compression (or other suitably formed) seal 10 is typically pre-placed in a mold which can include upper 54 and lower 56 mold halves, these being shown in reduced cutaway, phantom and exploded fashion and which are assembleable in order to define a negative interior cavity (see generally as referenced by interior mating recessed cavities or profiles at 58 and 60) within which the cowl panel 34 will be produced in a first injection stage molding operation, and prior to the second shot injection molding of the end muckets 38′ and 40′, wiper seals 46 and 48 and windshield edge seal 53.

A suitable channel, see at 62 with multiple spaced introduction locations 63, is associated with the lower mold half 56, can further be communicated with a first injection molding material (represented by reservoir 64 and such as again including any of a polypropylene, thermoplastic olefin or other suitable material for forming the cowl 34). Following formation of the cowl 34, a second injection molding operation is conducted for forming the end muckets 38′/40′, wiper seals 46/48 and windshield seal 53 and which can include the introduction of a second material, see as represented by a heated/fluidic reservoir 66 of TPE, TPV or like material which is communicated by a further channel network 68 including communicating with additional introduction locations 70, 72 and 74 defined in communication with the negative interior mold defining cavity associated with (by example) the upper mold 54, again for forming the end muckets 38′/40′, wiper pivot seals 46 and 48 and windshield edge seal 53.

Without limitation, options for ensuring the integrity of the second stage injection molding operation can include reconfiguring the mold assembly of FIG. 15 for the second stage process (such as shown and requiring additional fluid communicating channels and second TPE material fluid reservoir). This can also include the use of removable spacer components (not shown) during the first stage injection molding formation of the panel 34, such maintaining the spatial integrity of the mold interior during the first shot formation of the cowl and being thereafter removed prior to the second shot formation of the end muckets and wiper/windshield seals, this in order to prevent material infill or overflow from the first shot stage from impeding the subsequent formation of the end muckets and additional seal portions.

Additional envisioned formation strategies contemplate the removal of the first stage injection molded cowl 34 from an initial mold assembly and transferring to a second mold which is specially configured for the second injection molding operation forming the end muckets 38′ and 40′, wiper seals 46 and 48 and windshield seal 53, such as again by introduction of the second shot injection molded material into the mold at a given pressure.

Other materials for the muckets can include, without limitation, such as a cross linked polyethylene or fusion molded material. While it is envisioned that the compression seal 10 with mounting anchors can be fastened to the finished injection molded cowl with second stage molded TPE/TPV accessories, it also being envisioned that a reconfiguration of the previously extruded seal can be pre-placed within a suitable mold and to which the cowl and subsequent features are injection molded in a variation of the present method.

This could further include any alternately configured extruded compression seal 10 (regardless of construction and whether or not including integrally formed clips or anchor portions) being placed within an appropriate pocket or channel defined in a mating mold cavity half, in combination with either the injection molding formation or subsequent placement of the cowl panel 34. The placement of the extruded compression seal can also be conducted prior to or following the formation of the second stage injection molded formation of the TPE end muckets 38′ and 40′, wiper seals 46 and 48 and windshield seal 53.

As is also known, end muckets (also termed mucket seals) are defined in the relevant automotive art to reference any attaching or sealing portion secured or configured with a body panel, door or the like, not limited to a vehicle cowl, and which can also be provided in combination with the attachment of the previously formed extruded seal. End muckets as described in the present application are further understood to include any three dimensional boot or other multi-sided shaped article, such as which is formed of a TPE (thermoplastic elastomer) or any other suitable injection molded material.

Without limitation, the present method can also contemplate the injection molding of additional components or features, not limited to the end muckets and/or wiper seals, and can include the partial or entire formation of other plasticized components associated with any vehicle panel structure such as with or without any particular sealing structure (extruded or otherwise).

As further described, the seal can be reconfigured for installation into any of hood to radiator, rocker, front grille, rear trunk, deck lid or lift gate applications. Yet additional variants of the invention further envisioned the seal being reconfigured as a wiper or lip seal or other bulb-type seal having any desired form or shape and which is coextruded or tri-extruded in the manner previously described in order to be installed into a suitable panel or supporting structure.

The present invention also discloses a method for multi-stage injection molding of the cowl and subsequently, the pair of end muckets, windshield seals and wiper seals, this prior to or concurrent with the attachment of the pre-extruded compression seal. The method includes the steps of extruding an elongated seal so as to include an elongated body, first stage injection molding the cowl, and second stage injection molding the end muckets and other seals. Other steps include the injection molding of the end mucket portions, wiper seals and windshield seal further including injection molding a thermoplastic elastomer or a cross linked polyethylene material.

The present method may also include steps associated with the (pre) extruding the elongated seal 10 and for attaching the seal 10 to the cowl panel 34 (or other suitable body panel or other mounting structure), again both during or following the injection molding of the cowl and and subsequent TPE/TPV molded accessories. This can include the vehicle panel further including a cowl panel, and further including the step of injection molding a pair of wiper seals within spaced apart inner perimeter and aperture defining surfaces formed into the cowl panel.

The step of pre-extruding the elongated seal can further include extruding a first softer portion exhibiting a multi-sided and enclosed cross sectional profile and a second more rigid portion coextruded with the softer portion and which is adapted to being resistively engaged with an extending location associated with a vehicle panel, so that the first portion is supported upon the panel adapted to being contacted by a further component associated with the vehicle. The step of extruding the first softer portion further comprising forming a multi-sided profile in cross section with a hollow interior in order to facilitate controlled and cushioning collapse when compressed.

Other steps include forming an upper portion exhibiting a generally conical pointed upper end and a pair of outwardly flared lower ends and applying a slip coat over at least one of the first and second portions of the elongated seal body and including any type of plastic olefinic based grade or post applied and cured material. The step of extruding the second portion further including forming an elongated base material which includes an upper most planar shaped mounting ledge exhibiting a given width with opposite edges to which the lower ends of the first portion are co-extruded.

The step of extruding the second portion further includes forming a plurality of spaced apart and integrally projecting anchor portions projecting from a reverse side of the planar shaped mounting ledge. The step of forming the anchor portions can further include forming each of the anchor portions to have a central support and a pair of beams extending in a reversed angled fashion from an end of the central support, the beams terminating in configured edge profiles which facilitate mounting of the anchor portions within apertures defined in the vehicle panel.

Other steps include applying the seal in extending fashion along the vehicle panel by configuring an exposed and width extending channel within the cowl panel configured for receiving the elongated seal in resistive engaging fashion. The step of extruding the first portion can further include forming of any of a thermoplastic elastomer, thermal plastic vulcanite, or ethylene propylene diene rubber.

Yet additional steps include extruding the second portion by forming of any of a filled or unfilled polypropylene, a thermoplastic olefin, thermoplastic vulcanizate or a more dense ethylene propylene diene rubber. The step of applying the seal in extending fashion along the vehicle panel can also include incorporating the seal into any of a hood to radiator, rocker, front grille, rear trunk, deck lid or lift gate application.

Having described my invention, other and additional preferred embodiments will become apparent to those skilled in the art to which it pertains, and without deviating from the scope of the appended claims.

I claim:

1. A method for dual stage injection molding a cowl assembly, said method comprising the steps of:
injection molding a first plasticized material into a closed cavity configuration established between assembled mold halves in order to form a panel;
injection molding a second material in order to form at least a pair of three dimensional end mucket portions in spaced apart fashion upon the panel;
removing the completed panel from the mold; and
attaching an existing seal to the panel in extending fashion between the end muckets.

2. The method as described in claim 1, the vehicle panel further including a cowl panel, and further comprising the step of injection molding a pair of wiper seals within spaced apart inner perimeter and aperture defining surfaces formed into the cowl panel.

3. The method as described in claim 2, further comprising the step of injection molding a windshield seal along an edge of the panel.

4. The method as described in claim 3, said step of injection molding said end mucket portions, wiper seals and windshield seal further comprising injection molding any of a thermoplastic elastomer or a thermoplastic vulcanizate.

5. The method as described in claim 3, said step of injection molding said end mucket portions, wiper seals and windshield seal further comprising injection molding a cross linked polyethylene material.

6. The method as described in claim 1, said step of attaching the seal to the panel further comprising extending ends of the seals seating with opposing locations of the end muckets.

7. The method as described in claim 1, said step of attaching the seal further comprising resistively engaged with an extending location associated with a vehicle panel so that said seal is supported upon the panel and is adapted to being contacted by a further component associated with the vehicle not limited to a vehicle hood.
